(19) United States
(12) Patent Application Publication
(10) Pub. No.: US 2011/0213720 A1
(43) Pub. Date: Sep. 1, 2011

(54) Content Rights Management

(75) Inventors: Frey Waid, San Francisco, CA (US); Yi-Ling Su, Los Altos, CA (US); Shuehan Bishop, Redwood City, CA (US); Philip Snowberger, Daly City, CA (US)

(73) Assignee: GOOGLE INC., Mountain View, CA (US)

(21) Appl. No.: 12/853,189

(22) Filed: Aug. 9, 2010

Related U.S. Application Data
(60) Provisional application No. 61/233,791, filed on Aug. 13, 2009.

(51) Int. Cl. G06Q 10/00

(52) U.S. Cl. 705/310

(57) ABSTRACT

Rights are managed for content at a content server. The content server receives an asset representing intellectual property (IP) and a rights designation for the asset. The rights designation defines rules for usage of the IP represented by the asset. The asset and rights designation are received from an administrator of the asset. The content server receives content from content providers. The content includes one or more pieces of IP. The content server uses the asset to determine whether the received content is claimed by the administrator. If the content is claimed, rules in the rights designation for the asset are applied to the content.

### CROSS-REFERENCE TO RELATED APPLICATION

This application claims the benefit of U.S. Provisional Application No. 61/233,791, filed Aug. 13, 2009, which is incorporated by reference herein.

### BACKGROUND

1. Field of the Inventions

This invention generally relates to management of online content. In particular, the invention relates to making online content available in accordance with policies of an administrator of the content.

2. Description of the Related Art

The proliferation of web sites that allow users to upload multimedia content for mass viewing has brought with it a number of challenges, not the least of which has been how to detect and handle uploaded content in which other entities have rights.

Under the copyright laws of the United States and multiple other countries, a single work may have multiple copyright holders and various entities may hold other rights with regard to the content. For example, the composer, publisher, and music label are just some of the many different entities that may have different rights to a song and each entity may be entitled to control the use of their work, and/or to receive royalty payments under the various royalty schemes in force in a particular country. Videos have additional layers of complexity, including, for example, synchronization rights to any music played along with the videos.

While Performing Rights Organizations (PROs) such as The American Society of Composers, Authors and Publishers (ASCAP) exist to collect public performance royalties on behalf of the various copyright holders when their works are broadcast on radio or television, this type of collection mechanism is not available in the online environment; nor are performance rights sufficient—as noted above, other rights must also be taken into account.

Furthermore, before appropriate actions can be taken with regard to rights holders, content must be correctly identified. Given the nature of user-generated content (UGC), e.g., content provided by users to a web site, detecting content subject to the rights of others has proven to be very difficult. For example, a user may select a commercially available song, which is subject to copyright restrictions, and combine it with homemade video to which the user holds the copyright. Similarly, UGC including copyrighted video may escape detection by being slightly different, e.g., through cropping or editing, than the original video.

### SUMMARY

The above and other issues are addressed by a method, computer-readable medium, and content server for managing rights for content provided to a content server. An embodiment of the method comprises receiving an asset representing intellectual property (IP) and receiving a plurality of rights designation for the asset from a plurality of administrators of the asset. Each rights designation defines rules for usage of the IP represented by the asset. The method also comprises merging the plurality of rights designations to form a composite rights designation for the asset. The composite rights designation includes a policy specifying actions to perform on content including the IP represented by the asset and rules describing whether to perform the actions. The method further comprises receiving content including one or more pieces of IP, and claiming the content responsive to a determination that the content includes the IP represented by the asset. Responsive to claiming the content, the method applies the composite rights designation for the asset to the claimed content.

An embodiment of the medium includes a non-transitory computer-readable storage medium storing executable computer program instructions for managing rights for content provided to a content server. The computer program instructions comprise instructions for receiving an asset representing intellectual property (IP) and receiving a plurality of rights designation for the asset from a plurality of administrators of the asset. Each rights designation defines rules for usage of the IP represented by the asset. The instructions also comprise instructions for merging the plurality of rights designations to form a composite rights designation for the asset. The composite rights designation includes a policy specifying actions to perform on content including the IP represented by the asset and rules describing whether to perform the actions. The instructions further comprise instructions for receiving content including one or more pieces of IP, and for claiming the content responsive to a determination that the content includes the IP represented by the asset. Responsive to claiming the content, the instructions apply the composite rights designation for the asset to the claimed content.

An embodiment of the content server comprises a non-transitory computer-readable storage medium storing executable computer program instructions and a processor for executing the instructions. The computer program instructions comprise instructions for receiving an asset representing intellectual property (IP) and receiving a plurality of rights designation for the asset from a plurality of administrators of the asset. Each rights designation defines rules for usage of the IP represented by the asset. The instructions also comprise instructions for merging the plurality of rights designations to form a composite rights designation for the asset. The composite rights designation includes a policy specifying actions to perform on content including the IP represented by the asset and rules describing whether to perform the actions. The instructions further comprise instructions for receiving content including one or more pieces of IP, and for claiming the content responsive to a determination that the content includes the IP represented by the asset. Responsive to claiming the content, the instructions apply the composite rights designation for the asset to the claimed content.

### BRIEF DESCRIPTION OF THE DRAWINGS

FIG. 1 is a block diagram of a computing environment having a rights management system according to one embodiment.

FIG. 2 is a block diagram illustrating an example of a computer for use as a content server or for use by a provider, administrator, or viewer.

FIG. 3 is a block diagram illustrating modules within the content server according to one embodiment.

FIG. 4 is a block diagram illustrating the logical asset model implemented by the asset module according to one embodiment.

FIG. 5 is a block diagram illustrating the logical rights management model provided by the rights module according to one embodiment.

FIG. 6 is a flowchart illustrating a content-claiming process performed by the content server according to one embodiment.

FIG. 7 is a block diagram schematically illustrating an overview of the rights management system provided by the content server according to one embodiment.

FIG. 8 is a flowchart illustrating the operation of the content server to implement the rights management system according to one embodiment.

The figures depict an embodiment of the present invention for purposes of illustration only. One skilled in the art will readily recognize from the following description that alternative embodiments of the structures and methods illustrated herein may be employed without departing from the principles of the invention described herein.

### DETAILED DESCRIPTION

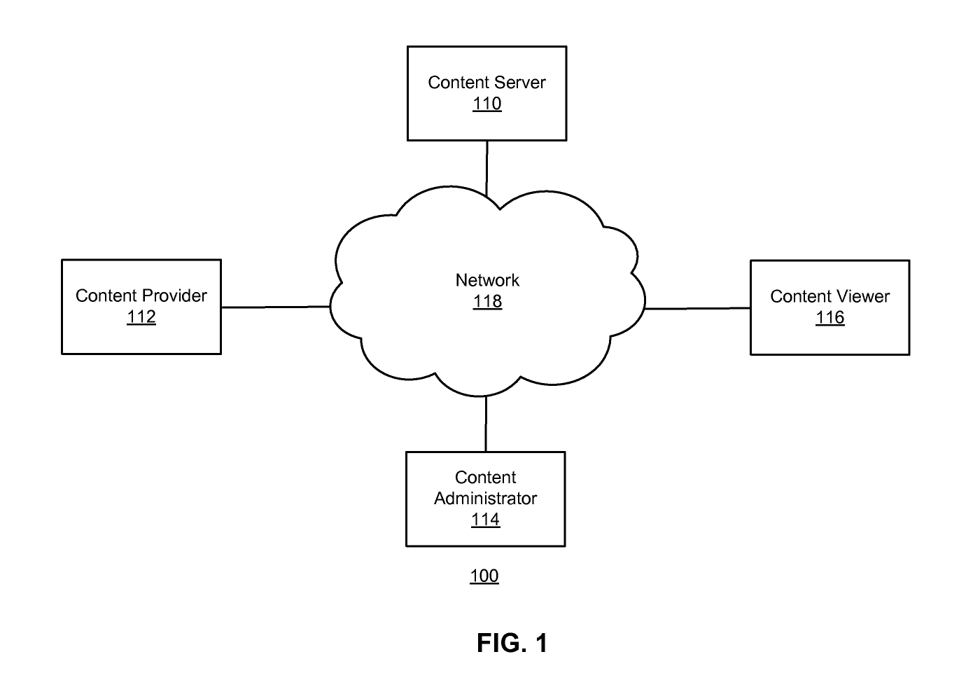

FIG. 1 is a block diagram of a computing environment 100 having a rights management system according to one embodiment. FIG. 1 illustrates a content server 110, a content provider 112, a content administrator 114, and a content viewer 116 connected by a network 118. For simplicity and clarity, the content provider 112, content administrator 114, and content viewer are respectively referred to as the “provider,” “administrator,” and “viewer” herein. Moreover, even though only single instances of these three entities are shown in FIG. 1, embodiments of the computing environment 100 can have thousands or millions of providers 112, administrators 114, and viewers 116. Embodiments can have multiple content servers 110 as well.

The content server 110 serves content provided by the providers 112 to viewers 116 via the network 118 according to policies specified by administrators 114. In one embodiment, the content includes video content and hence the consumer of the content is referred to as a “viewer” 116. The types of content can vary in different embodiments, and can include, for example, multimedia content such as movies, television programs, and music videos, audio content such as music, and textual content. In one embodiment, the content server 110 is located at a web site provided by YOUTUBE, LLC of San Bruno, Calif., although the content server can also be provided by another entity. The content server 110 includes a database storing the content and other data and a web server for interacting with the entities on the network 118.

The provider 112 is an entity that provides content to the content server 110 for serving to viewers 116. The provider 112 can be, for example, an individual user that generates a home movie and provides it to the content server 110 so that the movie can be viewed by the viewers 116. The individual may have no relationship with the content server 110, except perhaps an account at the content server 110. Content from such individuals is referred to as “user-generated content” (“UGC”). In contrast, the provider 112 can also be a partner of the content server 110, such as a production company or other content generator that has a commercial agreement to provide content to the content server 110. Content from partner providers is referred to as “provider-generated content”) (“PGC”). In a typical embodiment, the content provider 112 uses a device such as a personal computer or mobile telephone executing a web browser such as GOOGLE CHROME to provide the content to the content server 110.

The content provided by the provider 112 can include one or more “assets,” where an asset represents a piece of intellectual property (IP). For example, a home movie uploaded as UGC that includes no content from other sources may constitute a single asset. In contrast, a movie uploaded as PGC may include an embedded sound recording that, in turn, has an embedded composition. In this latter case, the movie, sound recording, and composition each constitute separate assets. As assets represent IP, an asset has a set of rights associated with it. These rights include, for example, reproduction rights, distribution rights, and public performance rights.

The administrator 114 manages rights for an asset by specifying a policy that the content server 110 applies to the asset. The administrator 114 can be the owner of one or more rights to an asset or another party acting on behalf of the rights owner. The administrator 114 makes a “claim” to content at the content server 110 that includes an asset administered by the administrator. A claim can be made, for example, by asserting ownership of the asset when providing content containing the asset to the content server 110, by using an automated process on the content server that identifies an instance of the asset in provided content, or by performing a manual search of content on the content server for the asset within the content.

The policy specified by the administrator 114 includes a set of rules that specify actions the content server 110 performs on content claimed by the administrator. The actions can include, for example, blocking viewing of the content, tracking usage of the asset in the content, and monetizing the content by, e.g., displaying ads in association with the content. In a typical embodiment, the administrator 114 uses a computer executing a web browser to interact with the content server 110 to perform tasks such as identifying assets, claiming content, and specifying policies.

The viewer 116 represents a consumer of the content served by the content server 110. The viewer 116 is typically a user using a web browser executing on a personal computer, mobile telephone, or television set-top box to interact with the content server 110 to view content provided by the content server 110. Depending upon the embodiment, the viewer 116 can receive the content as streaming media, as a download, or in another format. The viewer 116 may view the content, e.g., while accessing a web site provided by the content server 110 or while accessing a web site provided by a third party that serves content from the content server 110 via an embedded link or equivalent technique.

The network 118 enables communications among the entities connected to it. In one embodiment, the network 118 is the Internet and uses standard communications technologies and/or protocols. Thus, the network 118 can include links using technologies such as Ethernet, 802.11, worldwide interoperability for microwave access (WiMAX), 3G, digital subscriber line (DSL), asynchronous transfer mode (ATM), InfiniBand, PCI Express Advanced Switching, etc. Similarly, the networking protocols used on the network 118 can include multiprotocol label switching (MPLS), the transmission control protocol/Internet protocol (TCP/IP), the User Datagram Protocol (UDP), the hypertext transport protocol (HTTP), the simple mail transfer protocol (SMTP), the file transfer protocol (FTP), etc. The data exchanged over the network 118 can be represented using technologies and/or formats including the hypertext markup language (HTML), the extensible markup language (XML), etc. In addition, all or some of links can be encrypted using conventional encryption technologies such as the secure sockets layer (SSL), transport layer security (TLS), virtual private networks (VPNs), Internet Protocol security (IPsec), etc. In another embodiment, the entities use custom and/or dedicated data communications technologies instead of, or in addition to, the ones described above.

The computing environment 100 thus provides a flexible rights management system where the content server 110 can serve both UGC and PGC while handling the content in accordance with the wishes of the administrators 114 of the content. Different administrators 114 can claim different assets within a single piece of content and specify different policies for the assets. The system can additionally support different policies in different territories (e.g., countries).

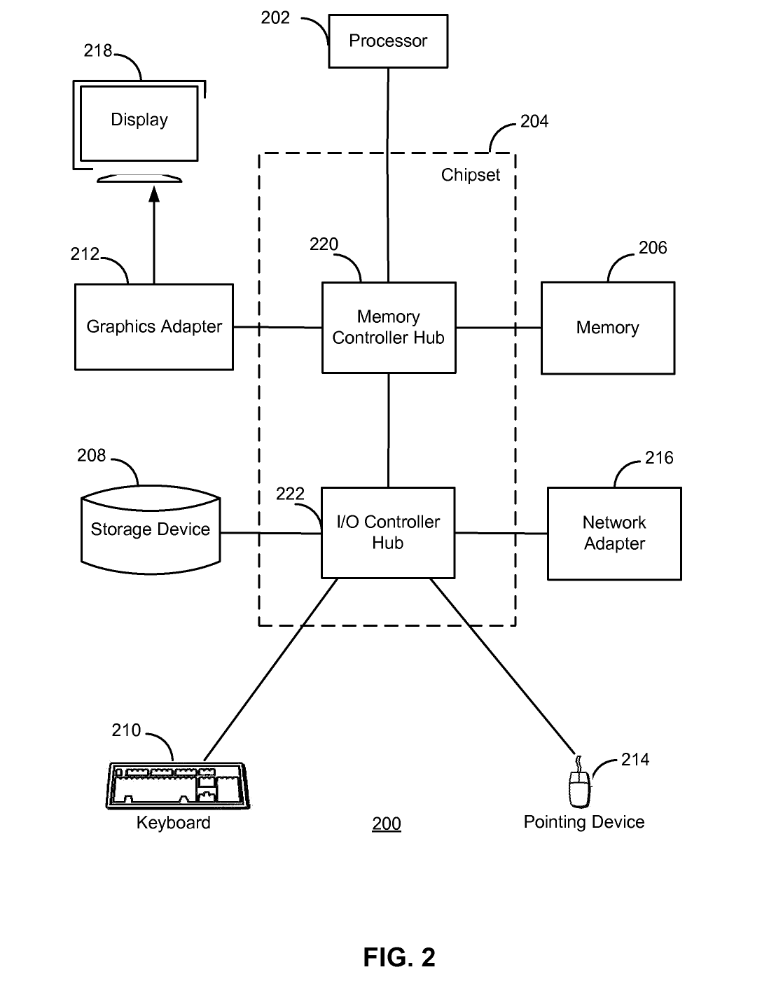

FIG. 2 is a block diagram illustrating an example of a computer 200 for use as a content server 110 or for use by a provider 112, administrator 114, or viewer 116. Illustrated are at least one processor 202 coupled to a chipset 204. The chipset 204 includes a memory controller hub 220 and an input/output (I/O) controller hub 222. A memory 206 and a graphics adapter 212 are coupled to the memory controller hub 220, and a display device 218 is coupled to the graphics adapter 212. A storage device 208, keyboard 210, pointing device 214, and network adapter 216 are coupled to the I/O controller hub 222. Other embodiments of the computer 200 have different architectures. For example, the memory 206 is directly coupled to the processor 202 in some embodiments.

The storage device 208 is a non-transitory computer-readable storage medium such as a hard drive, compact disk read-only memory (CD-ROM), DVD, or a solid-state memory device. The memory 206 holds instructions and data used by the processor 202. The pointing device 214 is a mouse, track ball, or other type of pointing device, and is used in combination with the keyboard 210 to input data into the computer 200. The graphics adapter 212 displays images and other information on the display device 218. The network adapter 216 couples the computer system 200 to the network 118. Some embodiments of the computer 200 have different and/or other components than those shown in FIG. 2.

The computer 200 is adapted to execute computer program modules for providing functionality described herein. As used herein, the term “module” refers to computer program instructions and other logic used to provide the specified functionality. Thus, a module can be implemented in hardware, firmware, and/or software. In one embodiment, program modules formed of executable computer program instructions are stored on the storage device 208, loaded into the memory 206, and executed by the processor 202.

The types of computers 200 used by the entities of FIG. 1 can vary depending upon the embodiment and the processing power used by the entity. For example, a mobile telephone used by a provider 112 to send content to the content server 110 typically has limited processing power, a small display 218, and might lack a pointing device 214. The content server 110, in contrast, may comprise multiple blade servers working together to provide the functionality described herein.

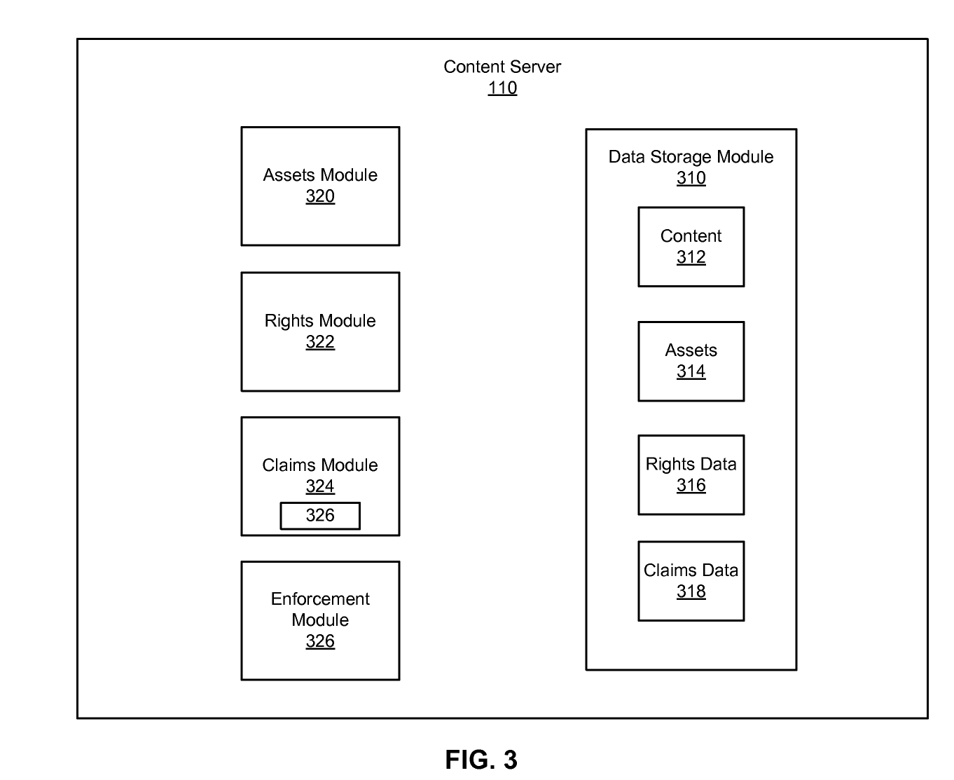

FIG. 3 is a block diagram illustrating modules within the content server 110 according to one embodiment. Some embodiments of the content server 110 have different and/or additional modules than the ones described here. Similarly, the functions can be distributed among the modules in a different manner than is described here. Certain modules and functions can be incorporated into other modules of the content server 110 and/or other entities on the network 118.

A data storage module 310 stores data used by the various modules of the content server 110. The stored data include content data 312 describing content uploaded by providers 112. As mentioned above, the content can include multimedia content such as movies, video content, audio content, and other forms of content such as textual content. The stored data also include asset data 314 describing assets identified by administrators 114, rights data 316 describing policies specified by administrators, and claims data 318 describing claims made by administrators. The data storage module 310 can be implemented by one or more database systems.

An assets module 320 provides functionality allowing administrators 114 to describe assets that can be contained in content stored by the content server 110. The term “asset” has slightly different meanings depending upon how it is used herein. “Asset” can refer to the IP represented by the asset. For example, the statement “content includes the asset” uses “asset” in this sense. “Asset” can also refer to a bundle of information describing the IP. For example, the statement “the asset includes ownership information” means that the bundle of information describing the IP includes ownership information; the IP itself does not necessarily include ownership information.

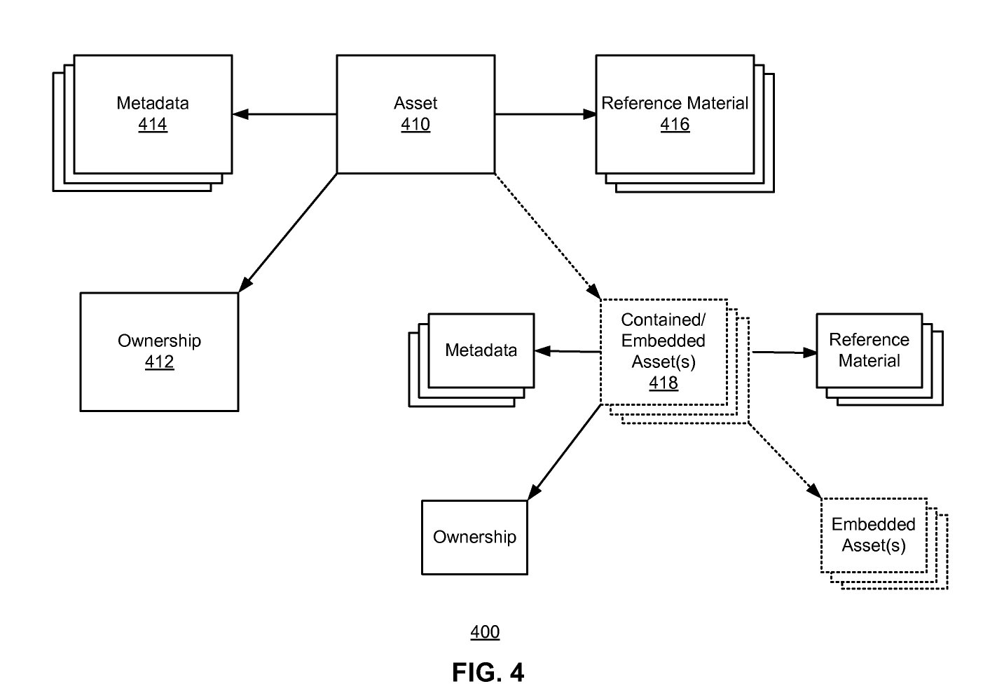

FIG. 4 is a block diagram illustrating the logical asset model 400 implemented by the asset module 320 according to one embodiment. The IP represented by the asset 410 has a specified asset type. One embodiment of the content server 110 recognizes asset types including music videos, sound recordings, compositions, movies, television programs, and web videos. Other embodiments can support different and/or additional asset types.

An asset 410 can specify ownership information 412. The ownership information 412 includes the name of the owner of the IP represented by the asset 410 and may also include other identifying information. An embodiment of the content server 110 tracks the territory (e.g., country or countries) where an owner claims ownership as well as the percentage of an asset 410 for which the owner claims ownership. Accordingly, an asset 410 can have different owners in different territories. In addition, a composition asset can have multiple owners within a single territory.

An asset 410 has associated metadata 414 that identify and describe the type of asset and the asset itself. In one embodiment, the metadata are a collection of data fields that identify and describe the asset 410. For example, the metadata for a sound recording can include the song title and the name of the artist featured in the recording. The metadata for a television program can include an episode number and a season number. The metadata can be used, e.g., to locate assets or to eliminate duplicate assets.

An asset 410 can have multiple versions of metadata, which could be provided by different administrators 114 of the asset or even by the same administrator. In one embodiment, any administrator 114 can provide metadata 410 about an asset, though typically an owner or rights holder for the asset will provide the metadata. Having comprehensive and accurate metadata improves the content server's ability to manage assets with multiple owners and to ensure that all of those owners can exercise their rights with respect to content that matches those assets.

Since there can be multiple versions of the metadata 414, an embodiment of the assets module 320 implements a scoring system to determine which set of metadata are active. The versions of the metadata are scored, and the highest scoring metadata are selected as the active metadata. The active metadata are used for reporting and display throughout the rights management system.

The scoring system generates scores for the metadata based on one or more of multiple factors. In one embodiment, for example, manually-edited metadata are given more weight because such metadata are presumed to have undergone a more rigorous verification process than metadata from automated sources. One embodiment of the scoring system gives higher weight to metadata that contain primary indexed fields which uniquely identify the asset 410. Different types of assets 410 have different primary indexed fields. For example, International Standard Recording Code (ISRC) and Global Release Identifier (GRid) numbers identify sound recordings, International Standard Musical Work Codes (ISWCs) identify compositions, and Tribune Media Services (TMS) identifiers identify movies and television programs. The scoring system associates the presence of a primary indexed field with greater confidence in the accuracy and verifiability of the corresponding metadata. In the case of a containing asset, such as an album or a television season series, a primary indexed field can also serve as a grouping identifier. For example, all of the songs on an album can be associated with the album's Universal Product code (UPC).

An asset 410 can also include reference material 416. Reference material are data used to match content to the asset. The reference material 416 can include a digital copy of the asset 410, such as an MPEG-2 file of a video or an MP3 file of a sound recording. The reference material 416 can also include an identifier of the asset 410, such as a digital fingerprint of the asset. The fingerprint can be, for example, a file containing frame-by-frame information about a video asset's content that can be used to match audio and/or video components of content. A single asset 410 can include multiple sets of reference material 416. For example, an asset 410 that is a video can have multiple reference materials showing the same video at different aspect ratios.

An asset 410 can further contain or embed one or more other assets (collectively identified by reference number 418 in FIG. 4). An asset 410 contains another asset 418 when multiple assets combine to form a new asset of a different type, but the new asset does not have substantively different reference material 416 than its component assets. Two examples are music albums, which contain a series of songs, and television seasons, which contain a series of episodes. A containing asset 410 organizes its component assets 418, but does not substantively change them. As such, a containing asset 410 has different metadata 414 than its component assets 418 but it does not have different reference material 416 than its component assets.

An asset 410 embeds another asset 418 when one or more assets appear within another asset. Whereas a containing asset organizes reference material 416, an embedding asset combines assets to create new reference material. As such, an embedding asset has different metadata 414 and different reference material 416 than the one or more assets it embeds. An embedded asset 418 can also embed additional assets. As an example, a movie program could have an embedded sound recording that, in turn, has an embedded composition. The use of embedded assets 418 and the associated rights allows content owners and administrators 114 to set policies for their assets even when those assets are contained within other content.

For example, suppose a music publisher owns a composition and grants a music label the right to use the composition in sound recordings. The music label, in turn, grants a production company the right to use its sound recording in a television program. Here, the television program is an asset 410 that contains an embedded asset 418 (the sound recording), and the sound recording, in turn, contains another embedded asset (the composition). Administers 114 of the television program can specify on a territory-by-territory basis whether they are also administering rights for the embedded assets.

Returning to FIG. 3, a rights module 322 provides functionality allowing administrators 114 to specify rights designations including policies that the content server 110 applies to assets 410. In one embodiment, an administrator 114 specifies a rights designation that defines rules and actions for usage (e.g., viewing) of an asset 410 (i.e., of the IP represented by the asset). The rights designation applies to any content that contains the asset 410, whether the content is UGC or PGC. The rights designation specifies the administrative rights granted to that administrator as well as the policies that will apply to the content under specified sets of circumstances. In this framework, a “policy” is a combination of one or more actions as well as a set of conditions, or rules, describing when the actions should be performed.

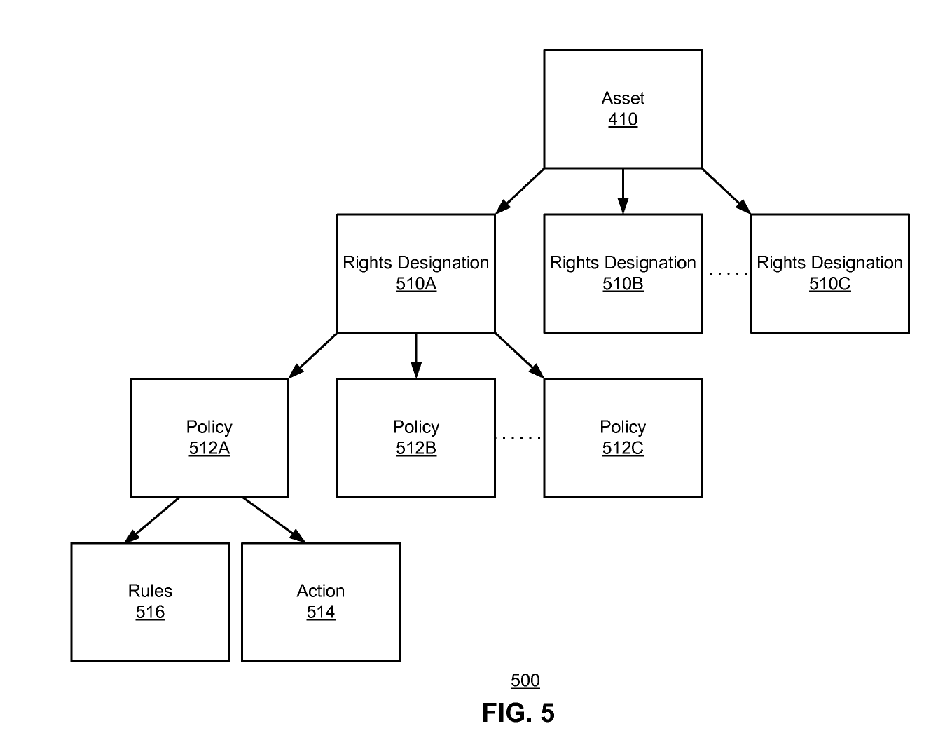

FIG. 5 is a block diagram illustrating the logical rights management model 500 provided by the rights module 322 according to one embodiment. FIG. 5 illustrates an asset 410 having multiple rights designations 510A, 510B, 510C. Each rights designation 510 is managed by an administrator 114, which is typically the content owner. However, in some cases third parties administer rights for an asset 410, such as collecting societies for composition assets or companies that administer rights for a television show in a particular territory. When rights are administered by a third party, the rights are typically granted by either a content owner or, in some cases, another rights holder.

The different rights designations 510 can belong to the same administrator 114 as long as the rights associated with each rights designation are different. Similarly, the rights designations 510 can belong to different administrators 114 for the asset 410. While an asset 410 can have multiple rights designations 510, each rights designation is associated with a single asset.

A rights designation 510 may apply only within a particular territory. For example, an administrator 114 who manages an asset 410 in the United States would not specify how claimed content that matches that asset would be handled in other countries. An asset 410 can have different rights designations 510 in the same territory if each designation specifies a different set of rights. A single administrator 114 can manage rights on behalf of rights owners in different territories. In fact, an administrator 114 can identify the territories where it is managing an asset 410 without identifying the actual rights owners in those territories.

Each rights designation 510 specifies one or more policies 512. A policy 512 is a combination of an action 514 with a set of rules 516 that explain when the action should be taken. For example, a rights designation 510 can specify one policy that covers downloadable copies of an asset 410 and another policy that covers streamed copies of the asset.

In one embodiment, the rights module 322 allows administrators 114 to establish default policies. An administrator 114 who is a partner of the content server 110 can establish a default usage policy specifying rules and actions for handling content that the partner provides as PGC. The content server 110 applies the default usage policy whenever the content provider is the partner.

The rights module 322 also allows an administrator 114 to establish a default policy specifying rules and actions for handling UGC that is automatically matched to an asset 410. Similarly, the rights module 322 allows an administrator 114 to establish a default policy specifying rules and actions for handling UGC that is manually matched to an asset 410. The default policy can be overridden after the claim is established.

Since multiple administrators 114 can hold rights to the same asset 410, such as different rights owners in different territories, the content server 110 accounts for all of those administrators' policies 512 when determining how to handle content that matches that asset 410. The combination of rules 516 and actions 514 in all of the rights designations 510 for an asset 410 constitute the “applied policy” for content that matches that asset. If content matches multiple assets, an embodiment of the content server 110 aggregates the rights designations 510 for all of the matching assets into a single applied policy for the content.

As mentioned above, a policy 512 is a combination of an action 514 with a set of rules 516 that explain when the action should be taken. The rules 516 describe how an administrator 114 administers an asset 410. In one embodiment, the rules 516 describe conditions that, when combined with an action 514, determine how the content server 110 handles a piece of content by specifying whether and how an administrator wants the content to be available. The administrator 114 can apply the rules 516 to individual content and/or to an arbitrary set of content.

An embodiment of the content server 110 supports rules that specify “claim,” “match,” and “watch” conditions. Claim conditions are rules 516 that differentiate based on the type of claim to the content. The claim conditions can specify different handling based on claim origin and content origin. Thus, the content server 110 can condition an action on whether the content was claimed via a manual search or via an automated system. Likewise, the content server 110 can condition an action on whether the content was provided by an administrator 114 or by another user.

Match conditions are rules 516 that differentiate based on the type of match between the content and the reference material for an asset 410. Match conditions can specify different handling based on the specific type of content that matches, such as whether the content matches the audio component, the visual component, or both the audio and visual components of an asset's reference material. Match conditions can also specify different handling based on the percentage of the content for which the administrator 114 holds rights. In addition, match conditions can specify different handling based on the length of the content segment that matches the asset's reference material. For example, a match condition can stipulate that more than a certain percentage of a video must match a reference file for an action to be performed. In one embodiment, match conditions are used only if the content was claimed via an automated system.

Watch conditions are rules 516 that differentiate based on the specific characteristics of the content viewer 116 requesting to access (e.g., watch) the content. Watch conditions can specify different handling based on the geographic location of the content viewer 116 who is accessing the content and based on the medium through which the viewer is trying to access the content. Administrators 114 can specify watch conditions that specify whether content can be syndicated via non-web platforms. Watch conditions can also specify different handling based on the web site where the content viewer 116 is trying to access the content. Administrators 114 can allow their content to be embeddable on only certain web sites.

The actions 514 describe how the content server 110 handles a piece of content if the rules 516 indicate that a policy 512 applies to an asset 410. One embodiment of the content server 110 supports the following actions 514, listed from most conservative to least conservative:

| | |
|---|---|
| Takedown - | The content server 110 sends a Digital Millennium |
| | Copyright Act (DMCA) takedown notice to the provider |
| | of the content. |
| Block - | The content server 110 prevents the content from |
| | appearing on the server's public web site. |
| Track - | The content server 110 lets the content appear on the |
| | public web site and flags the content so that the |
| | administrator 114 can track its usage. |
| Monetize - | The content server 110 lets the content appear on the |
| | public web site and monetizes the content. The monetizing |
| | can include, for example, showing advertisements in |
| | combination with the content and including the content in |
| | the administrator's revenue-sharing agreement with the |
| | content server 110. |

A policy 512 can also specify parameters for an action. For example, if a policy instructs the content server 110 to monetize matching content, the administrator 114 can specify acceptable methods of monetization by, e.g., only enabling certain types of ads to appear with that content. Such parameters can be specified for each piece of content.

Collectively, the rights designations 510 for an asset 410 constitute the composite rights designation for that asset. The rights module 322 combines all of an asset's rights designations 510 by merging the policies 512 that those rights designations define for the asset 410 into a merged policy (also called the “applied policy” above). This merging also reconciles conflicts between policies to determine how the content server 110 handles content that matches the asset 410. In one embodiment, the content server 110 also considers additional compliance policies that may be implicated in the rights designations 510 when determining the composite rights designation for an asset 410. For example, there might be additional policies due to contracts with administrators 114 of the content and/or local laws. In addition, the rights designations that are merged can include rights designations that are themselves composite rights designations. Thus, multiple composite rights designations can be merged into a new composite rights designation.

When content matches an asset 410, the content server 110 uses the asset's composite rights designation to determine the appropriate action 514 to take for the content in each territory. One embodiment of the content server 110 applies the most conservative action 514 specified in any rights designation 510 when different rights designations specify different actions for the same asset 410.

A rights designation 510 can specify different policies 512 for an asset 410 depending on whether the asset is used in an embedded or standalone context. An embodiment of the content server 110 support multiple models for administering rights for embedded assets. Under one model, the administrator 114 for an asset 410 may not have the rights to also set policies for embedded assets within that asset. In this case, the policies that an administrator 114 sets for an embedded asset also affect the composite rights designation of the embedding asset. Under another model, the administrator 114 for an embedding asset can specify whether it is administering rights for each individual embedded asset. Under a third model, the administrator 114 for an embedding asset can specify that, by default, it is administering rights for all embedded assets. In this case, the policies that administrators set for embedded assets do not affect the policies that the content server 110 enforces for the embedding asset. This third model is common for movie, television, and music video assets for which rights on embedded assets have already been cleared.

For example, suppose a music festival producer uploads recordings of the festival performances to the content server 110 so that each song constitutes a separate sound recording asset. In addition, a television news station uploads its coverage of the music festival to the content server 110, and a filmmaker produces a documentary about the festival and uploads the movie as well. The news coverage is a television asset, and the documentary is a movie asset. Both the television and movie assets feature a performance by the festival's headline act. As such, in both cases, the content server 110 views the performance as an embedded sound recording asset.

Even though the sound recording is featured in both videos, the music festival producer retains the rights to distribute and profit from the recording. In addition, suppose that the producer granted the filmmaker the right to use the recordings in the documentary such that the filmmaker (and not the festival producer) decides whether the film, including the embedded sound recording, can be served by the content provider 110. However, the news station did not obtain such rights, which means that the festival producer (and not the news station) decides whether the news segment that contains the embedded sound recording can be served by the content server 110. If the festival producer decides to block the news station from using the recording, then the content server 110 will protect the festival producer's rights by blocking the news segment from being served by the content server 110, muting the audio of the news segment, or performing another rights-protecting action.

Returning again to FIG. 3, a claims module 324 provides functionality allowing the content server 110 to claim content on behalf of the administrators 114. A claim links a piece of provided content that matches an asset 410 to a rights designation 510 associated with that asset.

In one embodiment, there are several ways for an administrator 114 to claim content. For example, the content provider 112 can create an asset 410 for the IP in the content and use the claims module 324 to indicate that the content includes the asset. In this instance, the content provider 112 is the administrator 114 and the content server 110 links the rights designation 510 specified by the administrator to the content including the asset 410.

In addition, the administrator 114 can use functions provided by the claims module 324 to automatically identify instances when content provided by a content provider 112 matches reference material 416, in whole or in part. To this end, the claims module 324 includes functionality for automatically matching content to reference material 416. One embodiment of the claims module 324 includes a fingerprinting module 326 that generates fingerprints of reference material 416 and content provided to the content server 110. A fingerprint can be based on all or part of the reference material/content. The fingerprint module 326 can, for example, generate a Message Digest 5 (MD5) hash of an entire provided video and determine whether the hash matches hashes of videos uploaded as reference material 416.

The fingerprint module 326 can also generate fingerprints that are frame-by-frame identifiers of videos uploaded as reference material 416 and determine whether the frame identifiers match fingerprints of frames of video in provided content. These frame-by-frame identifiers allow the claims module 324 to match content to reference material 416 even if only a subset of the content matches. It also accounts for file degradation and other modifications that a content provider 112 might make in an attempt to reduce the likelihood of a match.

The fingerprint module 326 can further generate fingerprints identifying audio content, such as sound recordings, contained in reference material 416. The fingerprint module 326 can compare these audio fingerprints to fingerprints of audio tracks of provided content to identify matches. For example, the fingerprint module 326 can use the audio fingerprints to identify music in the audio tracks of provided videos.

If provided content matches reference material 416, an embodiment of the claims module 324 establishes a claim for the content. As part of the claim, the claims module 324 aggregates the policies specified in the asset's rights designations 510 to create a policy 512 to be applied to the claimed content. The policy 512 specifies rules 516 describing the actions 514 to perform on the content.

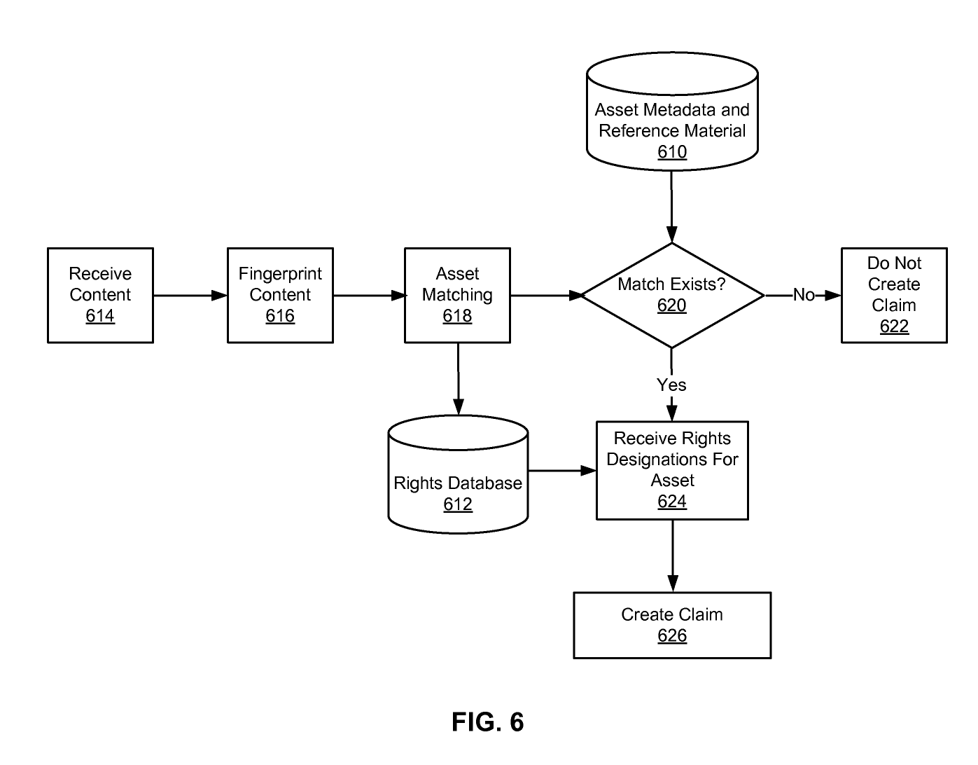

FIG. 6 is a flowchart illustrating a content-claiming process performed by the content server 110 according to one embodiment. FIG. 6 specifically shows an embodiment of an automated claiming process using functionality of the claims module 324. Other embodiments can have different and/or additional steps than the ones shown in FIG. 6, as well as support manual claiming processes.

A reference database holding metadata 414 and reference material 416 for assets 410 is established 610. As mentioned above, the metadata 414 are used identify and describe the assets 410 and the reference material 416 are data that can be used to match content to the assets. In addition, a rights database for the assets 410 is established 612. The rights database holds rights designations 510 that can apply to content provided to the content server 110.

At some point, the content server 110 receives 614 content. For example, a content provider 112 can upload a video having an audio track. The content server 110 fingerprints 616 the content by, e.g., generating identifiers of all or a portion of the content. In the video example, the fingerprints can include a fingerprint of the entire video, a fingerprint of frames of the video, and/or a fingerprint of all or a portion of the audio track for the video.

The content server 110 uses the fingerprints to determine 618 whether all or a portion of the received content matches any of the assets 410 known to the content server 110. In one embodiment, the content server 110 compares the fingerprints to the reference material 416 stored in the reference database 610 to determine whether there are any matches. If 620 the fingerprints do not match an asset 410, the content server 110 does not 622 create any claims for the content. If 620 one or more of the fingerprints match an asset 410, the content server 110 retrieves the rights designation 510 associated with the asset 410 from the rights database 612. The content server 110 uses the rights designation to create 626 a claim on behalf of the one or more administrators 114 who manage the rights designations for the received content.

Returning again to FIG. 3, an enforcement module 326 enforces policy-specified actions on claimed content. An embodiment of the enforcement module 326 receives a claim that identifies the claimed content and the policy 512 for the content. The enforcement module 326 analyzes the policy 512 to identify the set of rules 516 applicable to the content, and evaluates the rules to identify actions 514 to perform on the claimed content. As mentioned above, possible actions include takedown, block, track, and monetize. The enforcement module 326 performs the identified actions by, e.g., taking down or monetizing the content.

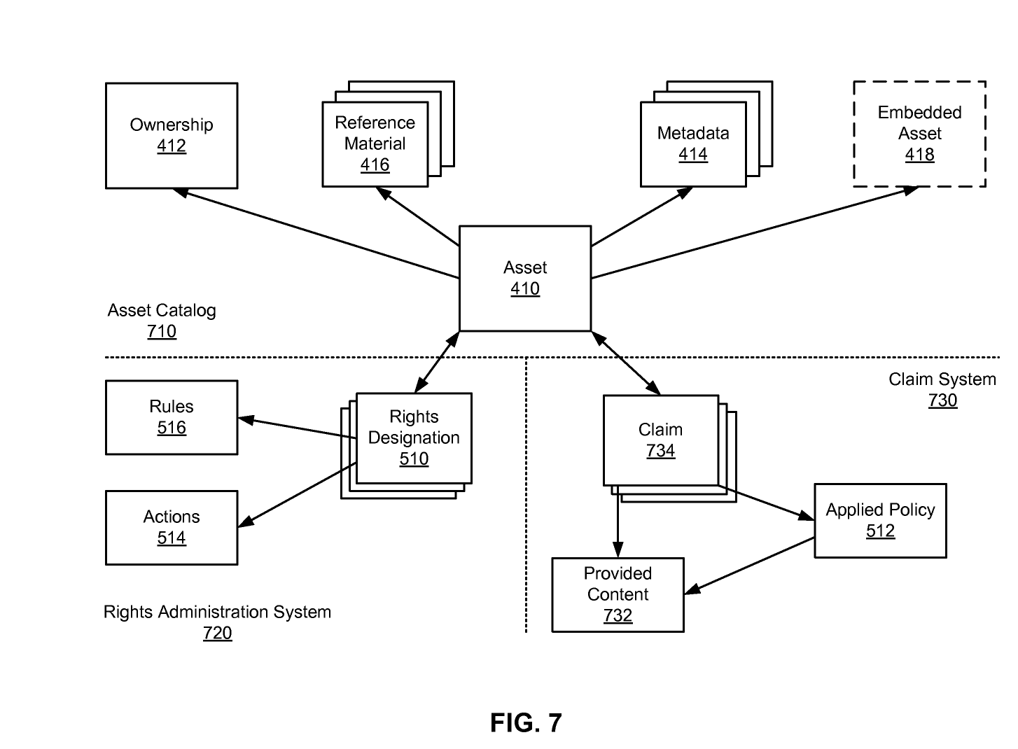

FIG. 7 is a block diagram schematically illustrating an overview of the rights management system 700 provided by the content server 110 according to one embodiment. Other embodiments can have different and/or additional elements than those shown in FIG. 7, and the system 700 can perform steps of the rights management process in different orders than the one described below.

The rights management system 700 includes an asset catalog 710 describing assets 410 created by administrators 114. The administrators 114 can include owners of rights to the assets 410 and/or parties acting on behalf of the rights owners. An asset 410 includes ownership information 412 identifying the owner of the asset. The asset 410 also includes metadata 414 which describe the asset, as well as reference material 416 that can be used to match content to the asset. The asset 410 can further include one or more embedded assets 418.

The rights management system 700 contains a rights administration system 720. The rights administration system 720 includes rights designations 510 for the assets 410 in the asset catalog 710. The rights designations 510 for an asset 410 specify the policies for the asset. The polices are comprised of rules 516 and actions 514, with the rules specifying actions to perform on content having the IP represented by the asset 410.

The rights management system 700 additionally includes a claim system 730. The claim system 730 receives content 732 that has been provided to the content server 110. The administrators 114 use the claim system 730 to claim 734 the content 732. The claiming can be performed using a manual or automated technique. The applicable policy 512 is applied to the claimed content 732.

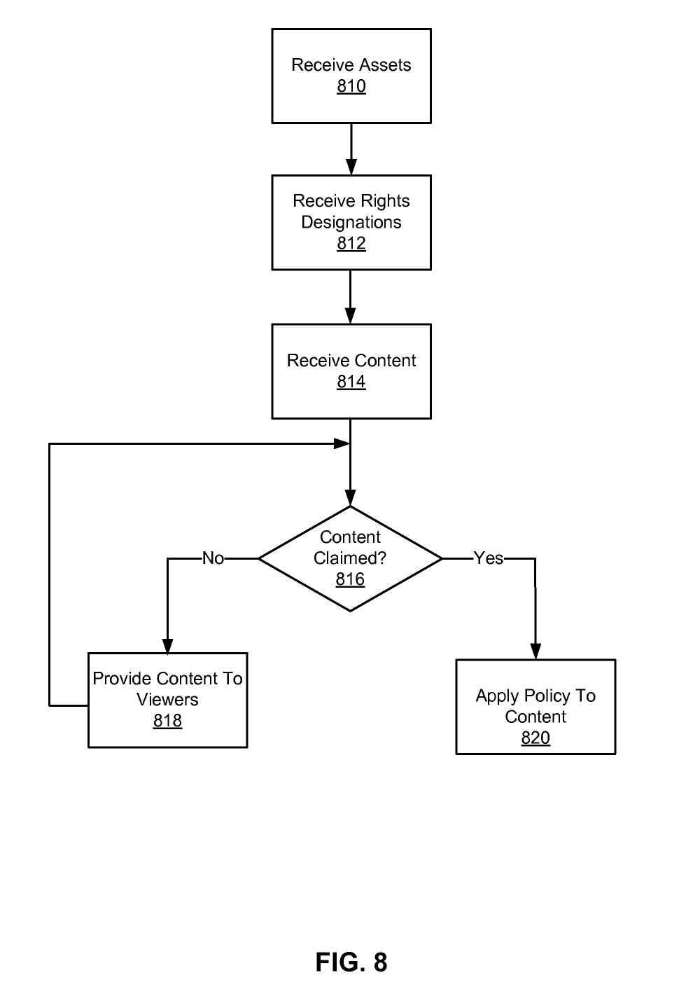

FIG. 8 is a flowchart illustrating the operation of the content server 110 to implement the rights management system 700 according to one embodiment. Other embodiments can have different and/or additional steps than the ones shown in FIG. 8, and perform the steps in different orders.

The content server 110 receives 810 assets 410 from administrators 416. The assets 410 include, among other things, reference material 416 that can be used to identify the assets in content 732. The content server 110 also receives 812 rights designations 510 for the assets 410. The rights designations 510 specify policies 512 applicable to the assets 410. Further, the content server 110 receives 814 content 732. The content can include UGC, such as content provided by individuals, and PGC, such as content received from production companies.

The content server 110 determines 816 whether the received content 732 has been claimed. This determination 816 can involve, e.g., automatically matching the content 732 to the reference material 416 for an asset 410 or receiving an indication from an administrator 114 that the content includes an asset. If 816 the content 732 is unclaimed, an embodiment of the content server 110 provides the content to viewers 116. In addition, the content server 110 periodically checks to determine 816 whether the content 732 is claimed in the future.

If 816 the content 732 is claimed, e.g., the content matches reference material 416 for an asset 410, the content server 110 applies 820 a policy 512 from the rights designation 510 for the asset to the content. To this end, the content server 110 can perform one or more actions such as taking down, blocking, tracking, and monetizing the content 732 based on the rules 516 specified by the policy 512. The policy 512 can allow the content to be provided 818 to viewers 116.

The above description is included to illustrate the operation of the embodiments and is not meant to limit the scope of the invention. The scope of the invention is to be limited only by the following claims. From the above discussion, many variations will be apparent to one skilled in the relevant art that would yet be encompassed by the spirit and scope of the invention.

1. A method of managing rights for content provided to a content server, comprising:
receiving an asset representing intellectual property (IP);
receiving a plurality of rights designations from a plurality of administrators of the asset, each rights designation defining rules for usage of the IP represented by the asset;
merging the plurality of rights designations to form a composite rights designation for the asset, the composite rights designation including a policy specifying actions to perform on content including the IP represented by the asset and rules describing whether to perform the actions;
receiving content, the content including one or more pieces of IP;
claiming the content responsive to a determination that the content includes the IP represented by the asset; and
responsive to claiming the content, applying the composite rights designation for the asset to the claimed content.

2. The method of claim 1, wherein the asset has associated metadata describing a type of IP represented by the asset and the asset type comprises an asset type from the set consisting of:
music video, sound recording, composition, movie, television program, and web video.

3. The method of claim 1, wherein the asset has associated ownership information identifying an owner of the asset.

4. The method of claim 3, wherein the ownership information identifies one or more of: a percentage of the asset owned by the owner and a territory in which the owner claims ownership of the asset.

5. The method of claim 1, wherein the asset is associated with multiple versions of metadata describing the asset and further comprising:
scoring the multiple versions of the metadata to identify a version of the metadata having a highest score; and
establishing the version of the metadata having the highest score as active metadata for the asset.

6. The method of claim 5, wherein the metadata are scored using one or more factors from a set of factors consisting of:
whether the metadata are manually-edited; and
whether the metadata contain primary indexed fields which uniquely identify the IP represented by the asset.

7. The method of claim 1, wherein merging the plurality of rights designations to form a composite rights designation for the asset comprises:
reconciling conflicts among the plurality of rights designations received from the plurality of administrators of the asset.

8. The method of claim 1, wherein the actions to perform on content including the IP represented by the asset comprise one or more actions from the set consisting of:
taking down the content by sending a copyright takedown notice to a provider of the content;
blocking the content by preventing the content from appearing on a content server; and
monetizing the content.

9. The method of claim 1, wherein the rules describing whether to perform the actions comprise one or more conditions from a set of conditions consisting of:
claim conditions specifying handling of the content based on an origin of the content and/or how the content was claimed;
match conditions specifying handling of the content based on how the content matches the IP represented by the asset; and
watch conditions specifying handling of the content based on characteristics of a viewer requesting access to the content.

10. The method of claim 1, wherein applying the composite rights designation for the asset to the claimed content comprises:
applying a most conservative action specified by the plurality of rights designations received from the plurality of administrators.

11. The method of claim 1, wherein receiving content comprises:
receiving content uploaded to a content server by a content provider.

12. The method of claim 11, wherein the asset representing the IP is received from a same content provider from which the content is received, and wherein claiming the content comprises:
receiving, from the content provider, an indication that the content includes the IP represented by the asset.

13. The method of claim 1, wherein applying the composite rights designation for the asset to the claimed content comprises:
evaluating the rules specified by the policy to identify one or more actions to perform on the claimed content.

14. The method of claim 1, further comprising:
providing the content to a content viewer responsive to the applied composite rights designation for the claimed content.

15. The method of claim 1, wherein the asset has associated reference material describing the IP represented by the asset, and wherein claiming the content comprises:
determining that the content matches the reference material.

16. The method of claim 15, wherein the reference material comprises one or more of: a digital copy of the IP represented by the asset, a digital fingerprint of the IP represented by the asset, and information describing a subset of the IP represented by the asset.

17. The method of claim 15, wherein determining that the content matches the reference material comprises:
automatically detecting that the received content matches the reference material.

18. The method of claim 15, wherein determining that the content matches the reference material comprises:
receiving an indication from an administrator of the asset that the received content matches the reference material.

19. A non-transitory computer-readable storage medium storing executable computer program instructions for managing rights for content provided to a content server, the computer program instructions comprising instructions for:
receiving an asset representing intellectual property (IP);
receiving a plurality of rights designations from a plurality of administrators of the asset, each rights designation defining rules for usage of the IP represented by the asset;
merging the plurality of rights designations to form a composite rights designation for the asset, the composite rights designation including a policy specifying actions to perform on content including the IP represented by the asset and rules describing whether to perform the actions;
receiving content, the content including one or more pieces of IP;
claiming the content responsive to a determination that the content includes the IP represented by the asset; and
responsive to claiming the content, applying the composite rights designation for the asset to the claimed content.

20. The computer-readable storage medium of claim 19, wherein the asset has associated metadata describing a type of IP represented by the asset and the asset type comprises an asset type from the set consisting of:
music video, sound recording, composition, movie, television program, and web video.

21. The computer-readable storage medium of claim 19, wherein merging the plurality of rights designations to form a composite rights designation for the asset comprises:
reconciling conflicts among the plurality of rights designations received from the plurality of administrators of the asset.

22. The computer-readable storage medium of claim 19, wherein the actions to perform on content including the IP represented by the asset comprise one or more actions from the set consisting of:
taking down the content by sending a copyright takedown notice to a provider of the content;
blocking the content by preventing the content from appearing on a content server; and
monetizing the content.

23. The computer-readable storage medium of claim 19, wherein the rules describing whether to perform the actions comprise one or more conditions from a set of conditions consisting of:
claim conditions specifying handling of the content based on an origin of the content and/or how the content was claimed;
match conditions specifying handling of the content based on how the content matches the IP represented by the asset; and
watch conditions specifying handling of the content based on characteristics of a viewer requesting access to the content.

24. The computer-readable storage medium of claim 19, wherein applying the composite rights designation for the asset to the claimed content comprises:
applying a most conservative action specified by the plurality of rights designations received from the plurality of administrators.

25. The computer-readable storage medium of claim 19, wherein applying the composite rights designation for the asset to the claimed content comprises:
evaluating the rules specified by the policy to identify one or more actions to perform on the claimed content.

26. The computer-readable storage medium of claim 19, wherein the asset has associated reference material describing the IP represented by the asset, and wherein claiming the content comprises:
determining that the content matches the reference material.

27. The computer-readable storage medium of claim 26, wherein the reference material comprises one or more of: a digital copy of the IP represented by the asset, a digital fingerprint of the IP represented by the asset, and information describing a subset of the IP represented by the asset.

28. The computer-readable storage medium of claim 26, wherein determining that the content matches the reference material comprises:
automatically detecting that the received content matches the reference material.

29. The computer-readable storage medium of claim 26, wherein determining that the content matches the reference material comprises:
receiving an indication from an administrator of the asset that the received content matches the reference material.

30. A content server for managing rights for content provided to the content server, comprising:
a non-transitory computer-readable storage medium storing executable computer program instructions comprising instructions for:
receiving an asset representing intellectual property (IP);
receiving a plurality of rights designations from a plurality of administrators of the asset, each rights designation defining rules for usage of the IP represented by the asset;
merging the plurality of rights designations to form a composite rights designation for the asset, the composite rights designation including a policy specifying actions to perform on content including the IP represented by the asset and rules describing whether to perform the actions;
receiving content, the content including one or more pieces of IP;
claiming the content responsive to a determination that the content includes the IP represented by the asset; and
responsive to claiming the content, applying the composite rights designation for the asset to the claimed content; and
a processor for executing the computer program instructions.

31. The content server of claim 30, wherein the asset has associated metadata describing a type of IP represented by the asset and the asset type comprises an asset type from the set consisting of:
music video, sound recording, composition, movie, television program, and web video.

32. The content server of claim 30, wherein merging the plurality of rights designations to form a composite rights designation for the asset comprises:
reconciling conflicts among the plurality of rights designations received from the plurality of administrators of the asset.

33. The content server of claim 32, wherein the actions to perform on content including the IP are represented by the asset comprise one or more actions from the set consisting of:
taking down the content by sending a copyright takedown notice to a provider of the content;
blocking the content by preventing the content from appearing on a content server; and
monetizing the content.

34. The content server of claim 32, wherein the rules describing whether to perform the actions comprise one or more conditions from a set of conditions consisting of:
claim conditions specifying handling of the content based on an origin of the content and/or how the content was claimed;
match conditions specifying handling of the content based on how the content matches the IP represented by the asset; and
watch conditions specifying handling of the content based on characteristics of a viewer requesting access to the content.

35. The content server of claim 30, wherein applying the composite rights designation for the asset to the claimed content comprises:
applying a most conservative action specified by the plurality of rights designations received from the plurality of administrators.

36. The content server of claim 30, wherein applying the composite rights designation for the asset to the claimed content comprises:
evaluating the rules specified by the policy to identify one or more actions to perform on the claimed content.

37. The content server of claim 30, wherein the asset has associated reference material describing the IP represented by the asset, and wherein claiming the content comprises:
determining that the content matches the reference material.

38. The content server of claim 37, wherein the reference material comprises one or more of: a digital copy of the IP represented by the asset, a digital fingerprint of the IP represented by the asset, and information describing a subset of the IP represented by the asset.

39. The content server of claim 37, wherein determining that the content matches the reference material comprises:
automatically detecting that the received content matches the reference material.

40. The content server of claim 37, wherein determining that the content matches the reference material comprises:
receiving an indication from an administrator of the asset that the received content matches the reference material.
